(19) United States
(12) Patent Application Publication
(10) Pub. No.: US 2016/0094656 A1
(43) Pub. Date: Mar. 31, 2016

(54) RELAYING DATA VIA A CLIENT DEVICE

(71) Applicant: AirWatch LLC, Atlanta, GA (US)

(72) Inventor: Erich Stuntebeck, Marietta, GA (US)

(21) Appl. No.: 14/501,810

(22) Filed: Sep. 30, 2014

(51) Int. Cl. H04L 29/08; G06Q 20/18; H04L 12/24; G06Q 10/08

(52) U.S. Cl. CPC H04L 67/1095; H04L 67/148; G06Q 10/087; G06Q 20/18; H04L 41/0654

(57) ABSTRACT

Disclosed are various embodiments for relaying data from a device that may not be equipped with a network interface. A data representation can be generated by the device on a display or via any other localized communication interface. The data representation can be captured by a computing device, which can relay the data to another computing device via a network. The data may be related to the operation of the device, such as status data with respect to the device or information about consumable resources associated with the device.

### BACKGROUND

Certain devices may not be equipped with a network interface or a data networking capability. These devices may, in certain situations, house data that can be useful to communicate to another device. However, in an effort to keep manufacturing costs low, a manufacturer may wish to omit potentially costly communications hardware and/or interfaces from the device.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example scenario according to various embodiments of the present disclosure.

FIG. 2 is a drawing of a networked environment according to various embodiments of the present disclosure.

FIG. 3 is a drawing of a data generating device according to various embodiments of the disclosure.

FIG. 4 is a drawing of a data generating device according to various embodiments of the disclosure.

FIG. 5 is a drawing of a data generating device according to various embodiments of the disclosure.

FIG. 6 is a flowchart illustrating one example of functionality implemented as portions of a data generating device according to various embodiments of the present disclosure.

FIG. 7 is a flowchart illustrating one example of functionality implemented as portions of a data relay application according to various embodiments of the present disclosure.

FIG. 8 is a schematic block diagram that provides one example illustration of a computing device employed in the networked environment of FIG. 1 according to various embodiments of the present disclosure.

### DETAILED DESCRIPTION

Various types of devices may generate data associated with the operation of a device, such as status information, inventory level data, etc. Data associated with the operation of various devices may be useful when communicated via a network so that other devices, services, and/or users may react to or act upon data associated with the operation of the device. Additionally, while many devices are increasingly equipped with local area networking and/or wide area networking capabilities, certain devices may not be equipped with networking capabilities by device manufacturers in an effort to keep manufacturing costs low, device or network security reasons, and other reasons.

Accordingly, embodiments of the disclosure can facilitate relaying of data from a first device via a computing device, such as a smartphone, mobile device, tablet computing device, or other device equipped with local area networking or wide area networking capability, to another computing device that may have a need or use for data generated by the first device. As one example, such a device that may be without local area networking or wide area networking connectivity or capability may comprise a peripheral device, such as a printer, that may generate data or information with respect to an operating status of the printer. Another example of such a device can include a piece of fitness equipment that may generate data regarding a usage session of the fitness equipment. As another example, such a device may include a vending machine that generates data with respect to inventory levels of items dispensed by the vending machine. In some embodiments, such a device may in fact be equipped with a local area networking or wide area networking interface, but may also operate according to embodiments of the disclosure as an alternative mechanism for communicating data generated by the device.

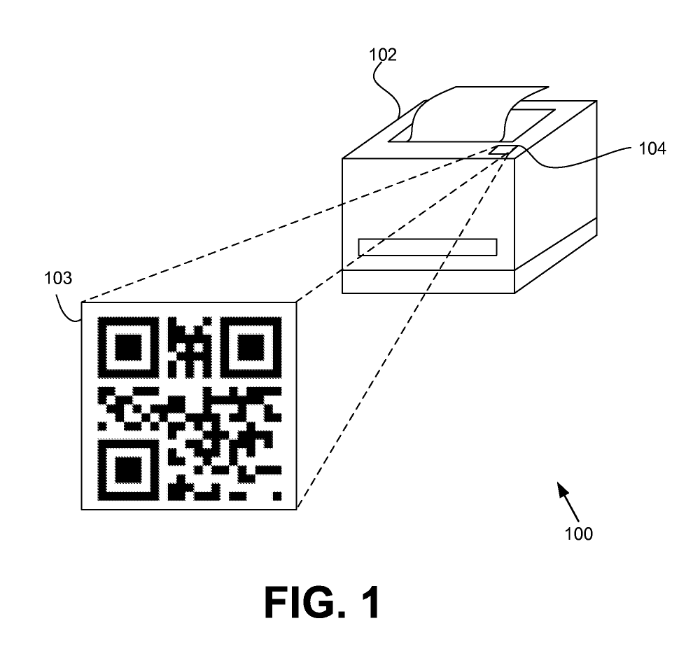

Accordingly, reference is now made to FIG. 1, which illustrates an example scenario 100 according to an embodiment of the disclosure. According to one embodiment of the disclosure, a printer device may be configured without a networking capability or without the ability to communicate data or information regarding its operation to certain other computing devices. Such a device is referred to herein as a data generating device 102. A data generating device 102 can include any type of device that is configured to generate data that is communicated via a localized communication interface of the data generating device 102 to a computing device, which then relays the data to another device. The other device can comprise a computing device that is configured to receive, process, store and/or act on the data received from the computing device that relayed the data generated by the data generating device 102.

Therefore, as shown in the example scenario of FIG. 1, a data generating device 102, or the printer device as in the example of FIG. 1, can generate a machine-readable representation of data that corresponds to the operation of the data generating device 102. In the scenario 100 shown in FIG. 1, the data generating device 102 can generate a visual representation of data, or a barcode representation, such as a quick-response (QR) code or two-dimensional barcode that is rendered on a display 104 associated with the device. The barcode can include a data representation 103 of the data corresponding to the operation of the data generating device 102. In some embodiments, the data representation 103 can include text, numerical data, alphanumeric data, or any other representation in which the data corresponding to the operation of the data generating device 102 can be communicated.

In the example of FIG. 1, the data representation 103 can communicate information about an operating status of the printer device, such as an inventory level of a consumable item or resource, such as an amount of paper, ink, toner, etc. The data representation 103 can also communicate other status data, such as information about malfunctions within the printer device or whether the device is operating normally. For example, the data representation 103 can indicate that a paper jam or other fault has rendered the device inoperable or in a malfunctioning state.

Accordingly, in one embodiment, a smartphone, mobile device, or other computing device with a localized data acquisition capability, such as a camera, radio-frequency identification (RFID) reader, near-field communication (NFC) reader, a personal area network communication interface, such as a BLUETOOTH capability, can capture the data representation 103 and relay data extracted from the data representation 103 to another device that is configured to consume, store or otherwise act on the data extracted from the data representation 103. For example, the data extracted from the data representation 103 can be relayed to another computing device configured to dispatch personnel to address a maintenance issue associated with the printer device, create a trouble ticket associated with the device, initiating order of additional consumable items with respect to the printer device, or initiate any other action in response to receiving the data.

In the following discussion, a general description of the system and its components is provided, followed by a discussion of the operation of the same.

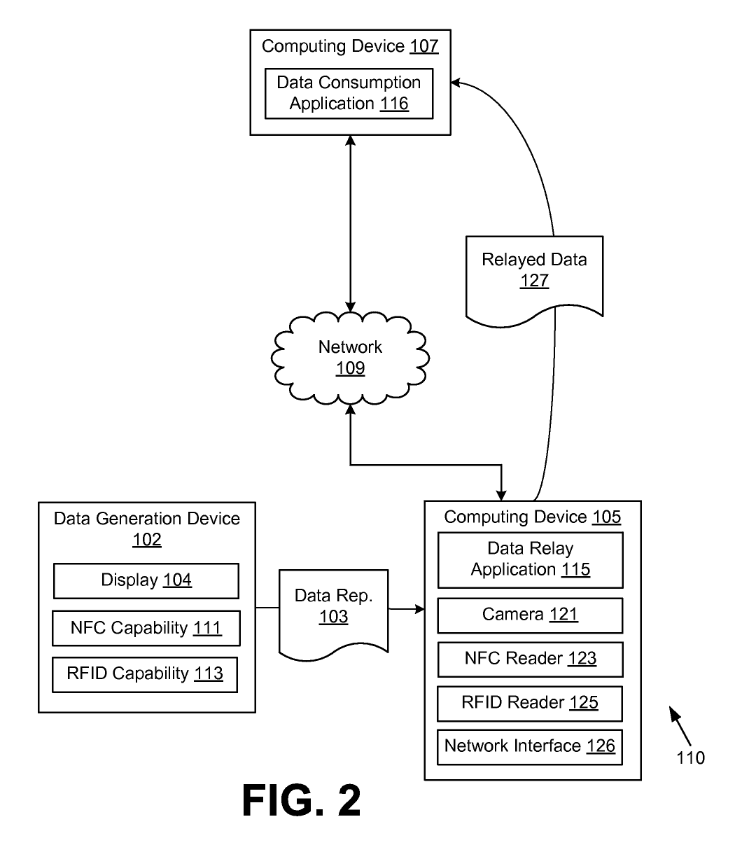

With reference to FIG. 2, shown is a networked environment 110 according to various embodiments. The networked environment 110 includes a data generating device 102, a computing device 105, and another computing device 107, which are in data communication with each other via a network 109. The network 109 includes, for example, the Internet, one or more intranets, extranets, wide area networks (WANs), local area networks (LANs), wired networks, wireless networks, other suitable networks, or any combination of two or more such networks. For example, such networks may comprise satellite networks, cable networks, Ethernet networks, telephony networks, and other types of networks.

The data generating device 102 can be equipped with one or more of various localized communication interfaces. For example, such a localized communication interface can comprise a display 104 that is configured to render a machine-readable data representation 103. As another example, a localized communication interface can comprise an NFC capability 111 that transmits data via an NFC protocol to another device with a similar or like capability. Accordingly, the data generating device 102 may be equipped with a contact point, or an area of the data generating device 102 that another NFC device should contact or be placed near in order to obtain data via the NFC capability 111. The localized communication interface can also comprise an RFID capability 113 that allows the data generating device 102 to transmit data to an RFID reader, such as an active RFID reader or a passive RFID reader. Accordingly, the data generating device 102 may be equipped with a corresponding contact point, or an area of the data generating device 102 that an RFID reader should contact or be placed near in order to obtain data via the RFID capability 113.

Additionally, while the example of a data generating device 102 is depicted with more than one localized communication interface, it should be appreciated that in many embodiments, the data generating device 102 may be equipped with only one localized communication interface. For example, in some scenarios, the data generating device 102 may be equipped with a display 104 but no other capability to communicate a machine readable data representation 103 to another computing device. As another example, the data generating device 102 may be equipped with an NFC capability 111 but no other capability to communicate a machine readable data representation 103 to another computing device.

The computing device 105 and 107 are representative of one or more computing devices that may be coupled to the network 109. The computing device 105, 107 may comprise, for example, a processor-based system such as a computer system. Such a computer system may be embodied in the form of a desktop computer, a laptop computer, a personal digital assistant, a cellular telephone, a smartphone, a set-top box, a music player, a web pad, a tablet computer system, a game console, an electronic book reader, or any other device with like capability.

The computing device 107 may also comprise a computing environment that may include, for example, a server computer or any other system providing computing capability. Such a computing environment may employ a plurality of computing devices 107 that may be arranged, for example, in one or more server banks, computer banks or other arrangements. Such computing devices may be located in a single installation or may be distributed among many different geographical locations. For example, the computing environment may include a plurality of computing devices that together may comprise a hosted computing resource, a grid computing resource and/or any other distributed computing arrangement. In some cases, the computing environment may correspond to an elastic computing resource where the allotted capacity of processing, network, storage, or other computing-related resources may vary over time. The computing environment may also include or correspond to one or more virtualized server instances that are created in order to execute the functionality that is described herein.

The computing device 105, 107 may include a display that comprises, for example, one or more devices such as liquid crystal display (LCD) displays, gas plasma-based flat panel displays, organic light emitting diode (OLED) displays, LCD projectors or other types of display devices. The computing device 105 may be configured to execute various applications, such as a data relay application 115 and/or other components. The data relay application 115 is configured to obtain a data representation 103, such as a QR code, RFID tag data, data obtained via NFC, or other representations of data from the data generating device 102 via a localized communication interface or a localized data acquisition capability that obtains data from an area in proximity to the computing device 105.

The data relay application 115 is configured to activate a localized data acquisition capability of the computing device 105, such as a front or rear face camera of the computing device 105 and acquire such a data representation 103. The data relay application 115 can then extract the data from the data representation 103 and transmit relayed data 127 to the other computing device 107 or any other device to which the data may be communicated via the network 109.

The computing device 105 can also be equipped with one or more forms of data acquisition capabilities or localized communication interfaces. For example, the computing device 105 can be equipped with a camera 121 or any other form of optical scanner, optical recognition device, or any other device that can capture a machine-readable data representation 103 that may be displayed on a display 104 of the data generating device 102. The computing device 105 can also be equipped with an NFC reader 123 that is configured to communicate with the data generating device 102 via an NFC capability 111 with which the data generating device 102 may be equipped in order to receive a data representation 103. The computing device 105 can also be equipped with an RFID reader 125 that can obtain tag that is potentially embedded in an RFID tag and/or transmitted to the RFID reader 125 from the data generating device 102 via one or more RFID protocols or configurations, such as an active-reader passive-tag protocol, a passive-reader active-tag protocol, or any other RFID configuration.

Additionally, the computing device 105 can also be configured with one or more network interface 126 or network capabilities, which can facilitate communication via the network 109. The network interface 126 can comprise a local area network or wide area network interface as well as a wired or wireless network interface through which the data relay application 115 can communicate with the computing device 107 to, for example, transmit relayed data 127.

Various systems and/or other functionality may be executed in the computing device 107 according to various embodiments. The components executed on the computing device 107, for example, include a data consumption application 116 and other applications, services, processes, systems, engines, or functionality not discussed in detail herein. The data consumption application 116 can receive relayed data 127 that is extracted from or based upon a data representation 103 captured by the data relay application 115 from a data generating device 102. The data consumption application 116 can represent any type of application executed by one or more computing devices 107 that is accessible via a network 109 that receives, processes, stores or otherwise acts on the relayed data 127 received from the data relay application 115.

As one example, the data consumption application 116 can represent an application that receives status data associated with the operation of a printer device or other device, appliance, etc., that is acting as a data generating device 102 and dispatches support personnel to address an issue that may arise in response to an error code, status message or other notification obtained as relayed data 127. For example, the data representation 103 may include data that relates to an inventory level of a consumable resource associated with the data generating device 102, such as paper level, ink levels, toner levels, inventory levels of items within a vending machine, or any other consumable resource. When such data is relayed to the data consumption application 116 as relayed data 127, the data consumption application 116 can initiate replenishment or ordering of supplies, refills, or replacement of the consumable resource.

In some embodiments, the data consumption application 116 can represent a web server or other type of server that serves data an application executed by the computing device 105, such as a browser application, in response to receiving relayed data 127. For example, the relayed data 127 can represent a request to resolve or retrieve a web site or a web page, which the data consumption application 116 can generate and transmit to the application executed by the computing device 105. In other embodiments, the data representation 103 can represent a data structure, such as an extensible markup language (XML) document that is embedded within a QR code or transmitted via NFC or RFID from which relayed data 127 can be extracted.

In some scenarios, a data capacity of a format associated with the data representation 103 may be exceeded, which may require the data relay application 115 to capture more than one data representation 103 from the data generating device 102 in order to extract data corresponding to the relayed data 127. For example, data generated by the data generating device 102 may exceed the maximum amount of data that can be encoded within a QR code or other visual identifier and/or an amount of data that can be encoded within a single RFID or NFC transmission. In such a scenario, the data generating device 102 can display a series of QR codes or visual identifiers that are sequentially displayed or make multiple RFID or NFC transmissions to the data relay application 115, which can assemble and extract the relayed data 127 that is forwarded to the data consumption application 116.

Next, a general description of the operation of the various components of the networked environment 110 is provided. As noted above, a data generating device 102 can generate data that is related to operation of a device. Additionally, a data generating device 102 may also be configured without a networking capability that enables communication with the data consumption application 116 via the network 109. Accordingly, the data generating device 102 can generate a data representation 103 of the data that is machine-readable and that is rendered upon a display 104.

The data relay application 115 executed by the computing device 105 can activate a localized data acquisition capability, such as the camera 121, in order to capture the data representation 103. As noted above, the data representation 103 may be split into multiple data representations 103. The data relay application 115 can then extract data from the data representation 103 and transmit the extracted data as relayed data 127 to another device, such as the computing device 107 executing a data consumption application 116. In this way, data can be obtained from a data generating device 102 that is potentially configured without networking capability and relayed to a computing device 107 that can store, process or otherwise act on the data.

For example, consider a data generating device 102 that is a vending machine device that vends various types of items. Such a device may be configured without a networking capability but may have a display 104 on which a QR code or other visual representation of data can be rendered. The data generating device 102 can embed within such a visual representation various information about the operation of the vending machine device or about inventory levels of the various items with which the vending machine device is stocked. Accordingly, in response to receiving the data representation 103 in which inventory data is embedded via the camera 121, the data relay application 115 can extract the inventory data and generate relayed data 127 that is transmitted to another computing device 107.

As another example, consider a data generating device 102 that is a treadmill or other fitness equipment device that may be used by a user. During or upon completion of a session of use of the treadmill, the treadmill may be configured to generate a data representation 103 in which usage data, such as a distance run, a time for a particular distance run, elevation change data, or any other data relating to usage of the fitness equipment. Such a data representation 103 can be captured by the user via the data relay application 115 using a localized data acquisition capability of the computing device 105, such as via an NFC capability 111 of computing device 105. The data relay application 115 can then generate relayed data 127 that is relayed via the network 109 to a data consumption application 116 by the computing device 105. In this example scenario, the data consumption application 116 may comprise a fitness tracking site or a fitness tracking application with which the user may upload or synchronize data.

As another example, consider a data generating device 102 that is an automobile driven by a user. The automobile may generate data with respect to usage of the automobile, such as maintenance alerts, fault data, fuel consumption data, tire pressure data, whether airbags have been deployed or an accident has been detected, battery charge levels, or any other data with respect to an automobile as can be appreciated. Additionally, an automobile may also be paired with a computing device 105 of a user, such as a smartphone or tablet computing device, via a personal area networking interface, such as BLUETOOTH. However, the automobile may not be equipped with a wide area networking capability. Accordingly, the automobile may generate a data representation 103 of data associated with usage of the automobile, which can be captured by the data relay application 115. In response to capturing the data representation 103, the data relay application 115 can generate relayed data 127 that can be transmitted to the data consumption application 116. In some embodiments, the data relay application 115 may also include location data in the relayed data 127 that corresponds to a location of the data generating device 102 and/or computing device 105.

In this scenario, the data consumption application 116 can be executed by a computing device 107 associated with an owner, a manufacturer, a dealer, mechanic, regulatory body, law enforcement or any other entity receiving data regarding automobile usage. The data consumption application 116, in response to receiving the relayed data 127 can, for example, dispatch maintenance or emergency personnel a location associated with the automobile, create a maintenance request or appointment, or generate any other type of notification or initiate an action with respect to the data generating device 102 or a user of the data generating device 102.

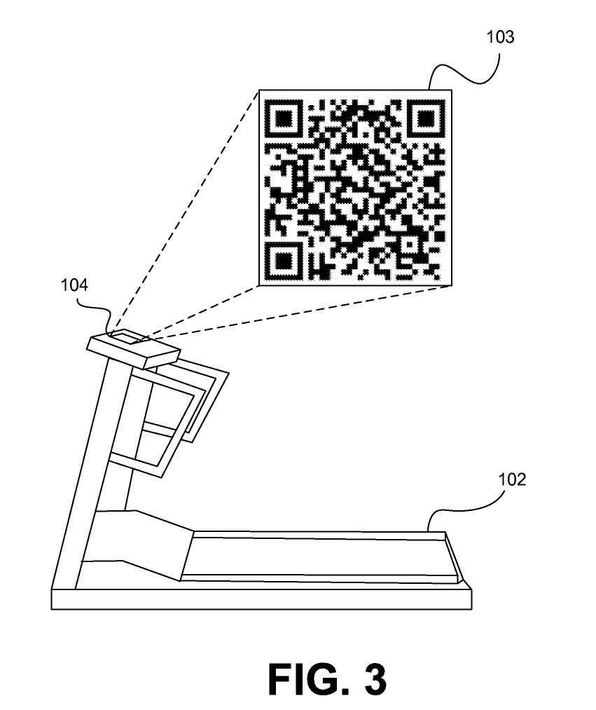

Referring next to FIG. 3, shown is an example of a data generating device 102 that comprises a treadmill. The examples shown in FIGS. 3-5 are merely meant to be illustrative and are not meant to limit embodiments of the disclosure to any particular type of device. As shown in FIG. 3, the treadmill is equipped with a display 104 that facilitates rendering of a visual identifier upon the display. In the example of FIG. 3, the display 104 can render a data representation 103 generated by the treadmill that can relate to usage data of the treadmill.

For example, the data generating device 102 can embed within the data representation 103 a data structure that contains usage data or status data with respect to the treadmill. For example, the data structure can comprise a XML data structure or any other structured data in which usage data can be embedded. Such usage data can include a distance run, timing information, calories burned, or any other data that may be tracked and generated by the treadmill with respect to usage.

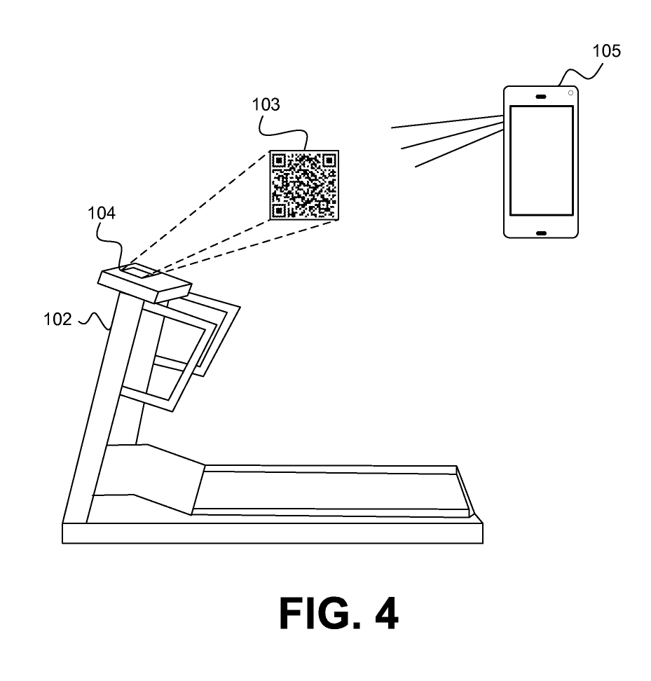

Continuing the example of FIG. 3, reference is now made to FIG. 4, which illustrates a scenario in which a computing device 105 can capture the data representation 103. In the example of FIG. 4, the data relay application 115 can activate a localized data acquisition capability of the computing device 105, such as a camera 121, which can initiate capture of the data representation 103 and extract data from the data representation. In response to capturing the data representation 103, the data relay application 115 can generate relayed data 127 that can be transmitted to another computing device 107 that may be potentially executing a data consumption application 116.

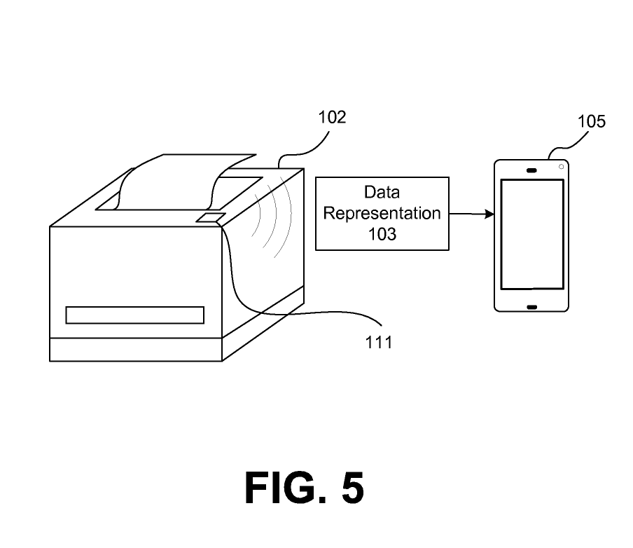

Reference is now made to FIG. 5, which illustrates an alternative scenario in which a computing device 105 can capture a data representation 103 generated by a data generating device 102. In the example of FIG. 5, the data relay application 115 can activate a localized data acquisition capability of the computing device 105, such as an NFC reader 123, which can initiate capture of the data representation 103 via an NFC capability 111 of the data generating device 102, which is a printer device in the non-limiting example of FIG. 5. The data relay application 115 can then extract data from the data representation 103 obtained via the NFC reader 123. In response to extracting data associated with the operation of the data generating device 102 from the data representation 103, the data relay application 115 can generate relayed data 127 that can be transmitted to another computing device 107 that may be potentially executing a data consumption application 116.

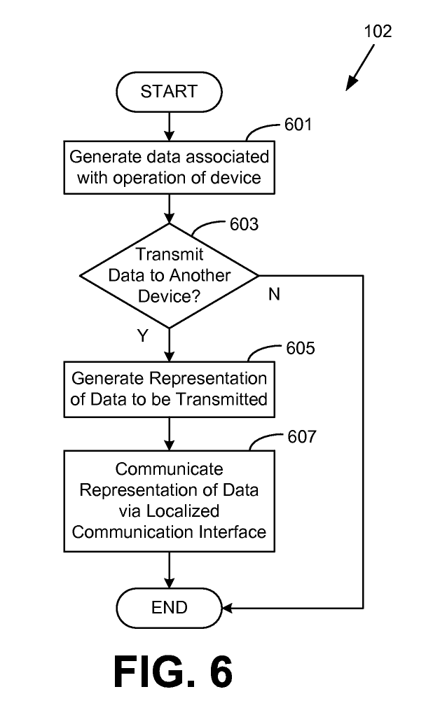

Referring next to FIG. 6, shown is a flowchart that provides one example of the operation of a portion of a data generating device 102 according to various embodiments. It is understood that the flowchart of FIG. 6 provides merely an example of the many different types of functional arrangements that may be employed to implement the operation of the portion of the data generating device 102 as described herein. As an alternative, the flowchart of FIG. 6 may be viewed as depicting an example of elements of a method implemented in the computing environment 110 (FIG. 1) according to one or more embodiments.

Beginning with box 601, the data generating device 102 generates data associated with the operation of the data generating device 102. As noted above, such data can include data regarding a status of the device, such as information regarding operating errors or faults encountered by the data generating device 102. Such data can also include data regarding inventory levels of consumable resources associated with the operation of the data generating device 102. At box 603, the data generating device 102 determines whether the data associated with the operation of the device should be transmitted to another device. If not, then the process shown in FIG. 6 ends. Otherwise, the data generating device 102 proceeds to box 605, where a data representation 103 is generated by the data generating device 102. At box 607, the data generating device 102 communicates the data representation 103 to the computing device 105 via a localized communication interface, such as a display 104, an NFC capability 111 and/or an RFID capability 113. Thereafter, the process shown in FIG. 6 proceeds to completion.

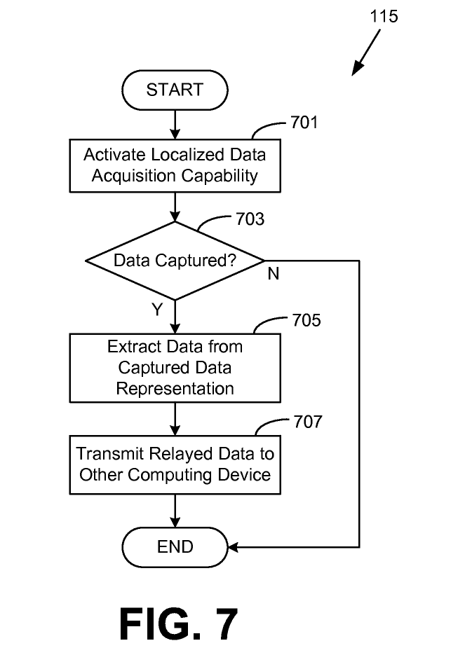

Referring next to FIG. 7, shown is a flowchart that provides one example of the operation of a portion of a data relay application 115 according to various embodiments. It is understood that the flowchart of FIG. 7 provides merely an example of the many different types of functional arrangements that may be employed to implement the operation of the portion of the data relay application 115 executed by a computing device 105 as described herein. As an alternative, the flowchart of FIG. 7 may be viewed as depicting an example of elements of a method implemented in the computing environment 110 (FIG. 1) according to one or more embodiments.

At box 701, the data relay application 115 can activate one or more localized data acquisition capability of the computing device 105, such as a camera 121, NFC reader 123, RFID reader 125, etc. At box 703, the data relay application 115 can determine whether data was captured by one or more of the localized data acquisition capabilities. If not, then the process shown in FIG. 7 can proceed to completion. Otherwise, at box 705, the data relay application 115 can extract the data from the captured data representation 103. At box 707, the data relay application 115 can transmit relayed data 127 to the computing device 107 executing a data consumption application 116. Thereafter, the process shown in FIG. 7 proceeds to completion.

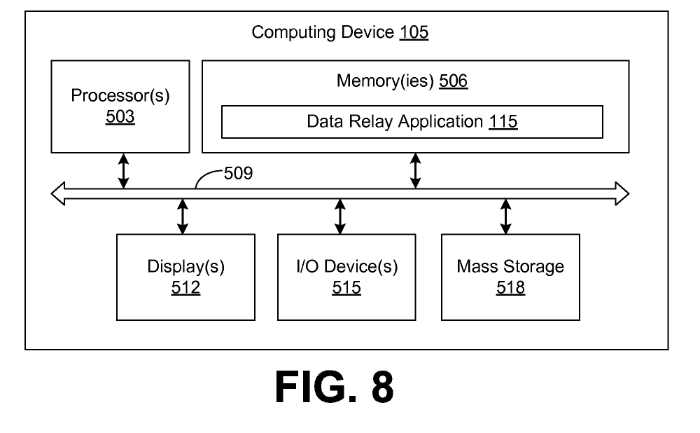

With reference to FIG. 8, shown is a schematic block diagram of the computing device 105 according to an embodiment of the present disclosure. The computing device 105 includes at least one processor circuit, for example, having a processor 503 and a memory 506, both of which are coupled to a local interface 509, respectively. The computing device 105 may comprise a mobile device, smartphone, computing device or like device. The local interface 509 may comprise, for example, a data bus with an accompanying address/control bus or other bus structure as can be appreciated.

Stored in the memory 506 are both data and several components that are executable by the processor 503. In particular, stored in the memory 506 may be the data relay application 115 and other data. In addition, an operating system may be stored in the memory 506 executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

The computing device 105 may include a display 512 that comprises, for example, one or more devices such as liquid crystal display (LCD) displays, gas plasma-based flat panel displays, organic light emitting diode (OLED) displays, LCD projectors, or other types of display devices, etc. The computing device 105 may also include one or more input/output devices 515 that may include, for example, a capacitive touchscreen or other type of touch input device, a camera 121, NFC reader 123, RFID reader 125, network interface 126, fingerprint reader, keyboard, etc. Additionally, the computing device 105 may also include some form of mass storage 518, which can comprise a hard drive, flash memory, or other storage devices.

Although the data relay application 115 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIG. 6-7 show an example of the functionality and operation of an implementation of portions of the data generating device 102 and/or data relay application 115, respectively. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIG. 6-7 show a specific order of execution, it is understood that the order of execution may differ from that which is depicted. For example, the order of execution of two or more blocks may be scrambled relative to the order shown. Also, two or more blocks shown in succession in FIG. 6-7 may be executed concurrently or with partial concurrence. Further, in some embodiments, one or more of the blocks shown in FIG. 6-7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the data relay application 115, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the data relay application 115, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 105 or in multiple computing devices. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It is emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a first computing device, the program, when executed by the first computing device, being configured to cause the first computing device to at least:
activate a localized data acquisition component of the first computing device, the localized data acquisition component comprising at least one of a camera, a radio-frequency identification (RFID) reader, or a near-field communication (NFC) reader;
capture, from at least one of a display or a contact point of a data generating device, a representation of data generated by the data generating device, the data generating device lacking connectivity to communicate the representation of data via a network to another computing device and wherein the representation of data is associated with an operating status of the data generating device;
extract, via the first computing device, the data generated by the data generating device from the representation; and
transmit, via the first computing device, the data to the a second computing device via a networking capability of the first computing device.

2. The non-transitory computer-readable medium of claim 1, wherein the data generating device comprises a peripheral device and the data comprises status information with respect to the peripheral device.

3. The non-transitory computer-readable medium of claim 2, wherein the peripheral device comprises a printer device, the data comprises status information with respect to operation of the printer device, and the program captures the representation of the data by initiating capture of an identifier shown on a display associated with the printer device via the camera.

4. The non-transitory computer-readable medium of claim 1, wherein the representation of the data generated by the data generating device comprises a visual data representation generated by the data generating device and shown on the display.

5. The non-transitory computer-readable medium of claim 4, wherein the visual data representation comprises a quick-response (QR) code.

6. The non-transitory computer-readable medium of claim 4, wherein the representation of the data comprises an extensible markup language (XML) data structure embedded within the visual data representation.

7. The non-transitory computer-readable medium of claim 4, wherein the representation of the data comprises status data corresponding to at least one of a consumable item associated with the data generating device.

8. A system, comprising:
a first device comprising a localized communication interface configured to communicate a data representation;
executable code executed by the first device, the executable code comprising:
logic that generates data associated with an operation of the first device, wherein the first device lacks a capability to communicate the data via a network to a second device;
logic that determines whether the data should be communicated to a third device in proximity to the first device;
logic that generates a representation of the data compatible with the localized communication interface; and
logic that transmits the representation of the data via the localized communication interface to the third computing device, wherein the second device captures the representation of the data via a data acquisition component and forwards the data to the second device via a network interface of the third device.

9. The system of claim 8, wherein the localized communication interface comprises at least one of: a display device, a radio-frequency identification (RFID) communication interface, a near-field communication (NFC) interface, or a personal area network communication interface and the executable code further comprises logic that generates the representation of the data compatible with the localized communication interface and logic that initiates transmission of the representation of the data to the third device via the localized communication interface.

10. The system of claim 8, wherein the representation of the data comprises a visual representation of the data, the visual representation comprising at least one quick-response (QR) code comprising a data structure incorporating the data.

11. The system of claim 10, wherein the at least one QR code comprises a plurality of QR codes comprising a plurality of data structures incorporating the data and the logic that transmits the representation of the data further comprises logic that sequentially displays the plurality of QR codes on a display device.

12. The system of claim 8, wherein the first device is integrated into a fitness equipment device and the data associated with the operation of the device corresponds to usage data associated with a usage session of the fitness equipment device.

13. The system of claim 8, wherein the data associated with the operation of the first device corresponds to a consumable resource associated with the operation of the first device, the data further corresponding to a notification regarding an inventory level of the consumable resource.

14. The system of claim 13, wherein the first device corresponds to a printer device and the consumable resource corresponds to at least one of an ink level, a toner level or an amount of paper.

15. The system of claim 13, wherein the first device corresponds to a vending machine and the consumable resource corresponds an inventory of items housed within the vending machine.

16. The system of claim 8, wherein the representation of the data is obtained by the third device and transmitted to an application configured to ingest the data executed by the second device using a network interface of the third device.

17. A method, comprising:
activating a localized data acquisition capability of a first computing device, the localized data acquisition capability comprising at least one of a camera, a radio-frequency identification (RFID) reader, or a near-field communication (NFC) reader;
capturing, via the localized data acquisition capability of the first computing device, a representation of data associated with a usage session of a data generating device, the representation of data being generated by the data generating device and communicated to the first computing device via at least one of a display device or a contact point of the data generating device, the data generating device lacking a wide area networking capability;
extracting, in the first computing device, the data generated by the data generating device from the representation; and
transmitting, from the first computing device, the data to a second computing device via a network interface of the first computing device.

18. The method of claim 17, wherein the representation of the data corresponds to a machine-readable data structure rendered on the display device associated with the data generating device.

19. The method of claim 17, wherein the representation of the data corresponds to a plurality of barcodes rendered on a display device associated with the data generating device, the plurality of barcodes being sequentially displayed by the display device.

20. The method of claim 17, wherein the data comprises a request to service the data generating device by replenishing a consumable resource or investigating a fault code associated with the data generating device.
